(19) United States
(12) Patent Application Publication
(10) Pub. No.: US 2024/0150526 A1
(43) Pub. Date: May 9, 2024

(54) CO-MODIFIED ORGANOPOLYSILOXANE AND CURABLE ORGANOPOLYSILOXANE COMPOSITION INCLUDING SAME

(71) Applicant: DOW TORAY CO., LTD., Shinagawa-Ku, Tokyo (JP)

(72) Inventors: Yuki YOKOUCHI, Ichihara-shi, Chiba (JP); Tomohiro IIMURA, Ichihara-shi, Chiba (JP); Tadashi OKAWA, Ichihara-shi, Chiba (JP)

(21) Appl. No.: 18/279,057

(22) PCT Filed: Feb. 28, 2022
(86) PCT No.: PCT/JP2022/008290

§ 371 Date: Aug. 26, 2023

(30) Foreign Application Priority Data
Mar. 5, 2021 (JP) 2021-034958

(51) Int. Cl. C08G 77/26; C08G 77/38; C09J 7/38; C09J 183/08

(52) U.S. Cl. CPC C08G 77/26; C08G 77/38; C09J 7/38; C09J 183/08; C08G 2170/40

(57) ABSTRACT

Provided is an organopolysiloxane compound serving as a raw material of an organopolysiloxane pressure-sensitive adhesive which has necessary and sufficient pressure-sensitive adhesive strength in a step such as temporary fixing or the like and can be easily peeled off from a substrate in a subsequent step; an organopolysiloxane pressure-sensitive adhesive composition containing the same; and a method for using the same. A chain co-modified organopolysiloxane containing a specific functional group having a (meth)acryl group (R^{A}) and a functional group having an alcoholic hydroxyl group (R^{OH}), wherein the amount of R^{A} is in the range of 0.10 to 10.0 mol % with regard to all silicon atom-bonded functional groups in the molecule, and the average amount of R^{OH} is in a range of 0.1 to 1.0 moles per mole of R^{A}.

### TECHNICAL FIELD

The present invention relates to a chain co-modified organopolysiloxane having both a (meth)acryl functional group and a group having an alcoholic hydroxyl group at a specific ratio in a molecule, and having both heat curability and photo-curability, a curable organopolysiloxane composition containing the same, an organopolysiloxane pressure-sensitive adhesive composition, and a method for using an organopolysiloxane pressure-sensitive adhesive composition in which a photo-curing reaction is performed after a heat curing reaction to reduce the pressure-sensitive adhesive strength of a pressure-sensitive adhesive to a substrate before and after the photo-curing reaction. Note that in the present invention, the pressure-sensitive adhesive includes a so-called pressure-sensitive adhesive (=PSA).

### BACKGROUND ART

Organopolysiloxane pressure-sensitive adhesive compositions are superior to acrylic and rubber pressure-sensitive adhesive compositions in electrical insulation, heat resistance, cold resistance, pressure-sensitive adhesion to various adherends, and transparency if necessary, and thus are widely used in the manufacture of semiconductor wafers, electronic and electrical devices such as smartphones, tablet PCs and the like, and display devices such as displays and the like. In particular, in recent years, when processing semiconductor wafers and during the assembly processes of electronic and electrical devices and displays, since members and protective films are temporarily fixed with relatively weak adhesive strength and the process proceeds by peeling off the temporarily fixed members and the like from the adhesive as the process progresses, there is a need for an adhesive composition that forms a pressure-sensitive adhesive that is slightly tacky as compared to conventional organopolysiloxane pressure-sensitive adhesive compositions.

In particular, in recent years, pressure-sensitive adhesive sheets including a pressure-sensitive adhesive coated on a base material made of a film are used in the dicing/pick-up/mounting process of semiconductor wafer processing, or the like, after the process of grinding the back surface of the wafer, and in these processes, there are situations where adhesive strength is required and situations where easy peelability is required. In other words, among these processes, the pressure-sensitive adhesive sheet must be sufficiently adhered to the semiconductor wafer without peeling off in order to protect the pattern surface of the semiconductor wafer during the back surface grinding process. Furthermore, after grinding, the adhesive sheet must be able to be easily peeled off from the semiconductor wafer. Similarly, in the dicing process of semiconductor wafers, high adhesiveness is required to prevent the cut and separated element pieces from peeling off of the adhesive sheet. On the other hand, in the pick-up process, the cut and separated element pieces must be easily peeled off of the adhesive sheet. In other words, low tackiness is required for adhesive sheets.

However, there is a trade-off relationship between pressure-sensitive adhesive strength for the purpose of fixing and protecting, and the ease of removal of the material. If a slightly tacky pressure-sensitive adhesive is used, there may be process defects due to insufficient pressure-sensitive adhesive strength in processes that require pressure-sensitive adhesive strength, such as temporary fixing, or the like. On the other hand, if the pressure-sensitive adhesive strength is high, the adhesive sheet may be difficult to peel off in a subsequent process, or process defects may be caused due to adhesive residue caused by the destruction of the cohesive layer. Therefore, there is a demand for a pressure-sensitive adhesive which has a necessary and sufficient pressure-sensitive adhesive strength in a step such as temporary fixing or the like and can be very easily peeled off from a substrate in a subsequent step.

On the other hand, organopolysiloxane compounds with a (meth)acryl functional group (=silicone methacrylate) are sometimes used in the fields of film materials and electrode materials (for example, Patent Document 1 and Patent Document 2). Furthermore, it has been proposed to use a co-modified organopolysiloxane compound, which may have a (meth)acryl functional group or the like, as a raw material for a curable composition such as a room temperature curable silicone rubber and a coating for paper (for example, Patent Document 3 and Patent Document 4). Furthermore, Patent Document 5 discloses a release coating agent containing a chain organopolysiloxane compound having a (meth)acryl functional group and a carbinol modified group.

However, the aforementioned documents neither describe nor suggest the use of: an organopolysiloxane compound having a chain (straight chain or branched chain) molecular structure which has a (meth)acryl functional group and another condensation reactive functional group at a specific ratio and provides coatable viscosity as a raw material for a pressure-sensitive adhesive; use of a co-modified organopolysiloxane compound having a plurality of curing reactive functional groups in a curing reaction mechanism of an isocyanate system used for curing a urethane material; a pressure-sensitive adhesive composition containing these compounds; and characteristics (particularly two-stage curability and change in pressure-sensitive adhesive strength) related to curing thereof.

### PRIOR ART DOCUMENTS

### Patent Documents

Patent Document 1: Japanese Unexamined Patent Application Publication 2017-206626
Patent Document 2: Japanese Unexamined Patent Application Publication 2017-202023
Patent Document 3: Chinese Patent Publication 107955579
Patent Document 4: French Patent Publication 2729406
Patent Document 5: International Patent Publication WO 2020/230723

### SUMMARY OF THE INVENTION

### Problem to be Solved by the Invention

The present invention has been made to solve the aforementioned problems, and an object of the present invention is to provide an organopolysiloxane compound that serves as a raw material for an organopolysiloxane pressure-sensitive adhesive which has a necessary and sufficient pressure-sensitive adhesive strength in a step such as temporary fixing or the like and can be very easily peeled off from a substrate in a subsequent step. Another object of the present invention is to provide: a curable organopolysiloxane composition containing the organopolysiloxane compound; an organopolysiloxane pressure-sensitive adhesive composition containing the same; and a method of using the organopolysiloxane pressure-sensitive adhesive composition.

### Means for Solving the Problem

As a result of conducting diligent research on the problem described above, the present inventors arrived at the present invention. In other words, the object of the present invention can be achieved by a specific amount of a chain co-modified organopolysiloxane containing a silicon-bonded functional group containing an acryl group or a methacryl group and a silicon-bonded functional group containing at least one alcoholic hydroxyl group or the like in a molecule. In addition, the object of the present invention can be achieved by a curable organopolysiloxane composition and an organopolysiloxane pressure-sensitive adhesive composition containing the co-modified organopolysiloxane.

The co-modified organopolysiloxane of the present invention has both heat-curing and photo-curing properties; therefore, the pressure-sensitive adhesive layer, which is a semi-cured material containing the co-modified organopolysiloxane, is formed by a heat-curing reaction, followed by a photo-curing reaction to cure completely. Therefore, the adhesive strength of the pressure-sensitive adhesive layer to the base material decreases markedly before and after the photo-curing reaction. As a result, the pressure-sensitive adhesive layer of the present invention has a necessary and sufficient pressure-sensitive adhesive strength after heat curing, and is then irradiated with a high energy beam to be photo-cured, whereby the pressure-sensitive adhesive strength is reduced and easy releasability can be realized.

### Effect of the Invention

The present invention can provide: an organopolysiloxane compound which is a chain co-modified organopolysiloxane having both heat curability and photo-curability and which is a raw material for an organopolysiloxane pressure-sensitive adhesive, in which a semi-cured material after heat curing has necessary and sufficient pressure-sensitive adhesive strength and a cured material after photo-curing reaction can be very easily peeled from a substrate. Furthermore, the present invention can provide: a curable organopolysiloxane composition containing the organopolysiloxane compound, in particular, an organopolysiloxane adhesive composition in which the adhesive strength of the pressure-sensitive adhesive layer to the base material is significantly reduced before and after the photo-curing reaction and easy release can be facilitated; and a method of using the same.

In particular, curable organopolysiloxane compositions containing the co-modified organopolysiloxane of the present invention have a coatable viscosity and excellent curability, and the curing reaction can provide a cured material (especially cured films) with good adhesion to the substrate material and excellent transparency. Furthermore, the present invention can provide a silicone-based pressure-sensitive adhesive layer/close adhesion layer whose pressure-sensitive adhesive strength changes before and after a photo-curing reaction, and can provide: a use as a protective member in a wide range of applications; and a manufacturing method and a protection method including an apparatus or a device provided with the same.

### MODE FOR CARRYING OUT THE INVENTION

[(A) Co-Modified Organopolysiloxane]

The co-modified organopolysiloxane of the present invention is a chain-type polysiloxane molecule, which may be linear or have a branched-chain structure with some branches. Such a co-modified organopolysiloxane may have a siloxane unit (M unit) expressed by R₃SiO_{1/2} at a molecular chain end, a main chain essentially configured of a siloxane unit (D unit) expressed by R₂SiO_{2/2}, and a siloxane unit (T unit) expressed by RSiO_{3/2} and/or a siloxane unit (Q unit) expressed by SiO_{4/2} providing a branched structure to a portion of the main chain, and may have, within a scope that does not impair the technical effect of the present invention, a divalent linking group such as a silalkylene bond or the like on a portion between siloxane units. R above each independently represents a monovalent organic group, and of all the Rs, at least one is a silicon-bonded functional group (R^{A}) containing an acryl group or a methacryl group described later, and at least one is a silicon-bonded functional group (R^{OH}) containing at least one alcoholic hydroxyl group. Note that from the perspective of crosslinking reactivity, at least two of R in all the siloxane units configuring the co-modified organopolysiloxane are preferably silicon-bonded functional groups (R^{OH}).

Suitably, the co-modified organopolysiloxane of the present invention has a linear or branched chain polysiloxane structure in which at least 90 mol % of all siloxane units, excluding the ends of the molecular chain, are D units, such that 95 to 100% of all units are D units, and is particularly preferably a linear co-modified organopolysiloxane. Note that a linear polysiloxane structure is one that includes only M units at both ends and D units configuring the main chain.

The co-modified organopolysiloxane of the present invention is not particularly restricted in terms of siloxane degree of polymerization, but from the viewpoint of providing the curable organopolysiloxane composition containing the organopolysiloxane with a coatable viscosity, a siloxane degree of polymerization in a range of 10 to 10,000 is preferable, and a range of 25 to 2,000 is more preferable. When a resinous organopolysiloxane containing a large amount of the T units and Q units and an organopolysiloxane having a high degree of polymerization are used, coating of the curable composition may become difficult.

Such a co-modified organopolysiloxane is expressed by the above siloxane units by the following formula.

M₍₂₊ₘ₊₂ₚ₎DₙTₘQₚ Formula:

In the formula, n is a positive number, n and m are 0 or positive numbers, “2+m+2p+n+m+p”, which is the total number of siloxane units (in other words, the degree of siloxane polymerization), is a number in the range of 10 to 10,000, and at least 90 mol % of all of the siloxane units excluding the end M unit are the D unit. Note that in the case of a straight chain polysiloxane structure, the co-modified organopolysiloxane of the present invention is expressed by MDₙM, and n+2 is a number in the range of 10 to 10,000.

The co-modified organopolysiloxane of the present invention contains in a molecule: a silicon-bonded functional group (R^{A}) containing an acryl group or methacryl group; and a silicon-bonded functional group (R^{OH}) containing at least one alcoholic hydroxyl group. Herein, the silicon-bonded functional group (R^{A}) is a functional group exhibiting photo-curability by irradiation with a high energy beam in the presence of a photo-radical polymerization initiator, and the silicon-bonded functional group (R^{OH}) is a functional group exhibiting heat curability in the presence of a condensation reaction catalyst. The co-modified organopolysiloxane of the present invention has both heat-curable and photo-curable silicon-bonded functional groups in the same molecule. Therefore, a pressure-sensitive adhesive layer formed from a semi-cured material after a heat curing reaction has a high initial adhesive force, and when the semi-cured material is irradiated with a high energy beam, the pressure-sensitive adhesive strength is greatly reduced, and easy releasability can be realized.

In order to achieve the property where the pressure-sensitive adhesive changes to become an easily releasable cured material by irradiation with a high energy beam, the co-modified organopolysiloxane of the present invention must contain a silicon-bonded functional group containing an acryl group or a methacryl group (R^{A}) in a range of 0.10 to 10.0 mol %, preferably in a range of 0.20 to 5.0 mol %, and more preferably 0.30 to 5.0 mol % with respect to all functional groups bonded to silicon atoms configuring the polysiloxane (all Rs in each siloxane unit described above). Furthermore, from the perspective of providing a semi-cured material with excellent initial adhesive force by a heat curing reaction, the amount of silicon atom-bonded functional groups (R^{OH}) containing at least one alcoholic hydroxyl group must be in a range such that the average amount is 0.1 to 1.0 mols, preferably in a range of 0.2 to 1.0 mols, for each mole of silicon atom-bonded functional groups having an acryl group or a methacryl group in a molecule. When the amount of the photo-curable silicon-bonded functional group (R^{A}) is less than the lower limit, the photo-curing reaction does not sufficiently proceed, and the pressure-sensitive adhesive properties may not change to an easily releasable cured material. When the amount exceeds the upper limit, problems such as side reaction and coloring may occur. When the amount of the heat-curable (condensation-reactive) silicon-bonded functional group (R^{OH}) is less than the lower limit, the initial adhesive properties may not be realized. On the other hand, when the amount exceeds the upper limit, excess hydroxyl groups may result in no change in pressure-sensitive adhesive properties to an easily peelable cured material. Note that from the perspective of crosslinking reactivity, at least two of all the functional groups bonded to silicon atoms configuring the polysiloxane (all Rs in each siloxane unit described above) are preferably silicon-bonded functional groups (R^{OH}).

Herein, the silicon-bonded functional group (R^{A}) containing an acryl group or methacryl group is expressed by the following.

### General Formula (1):

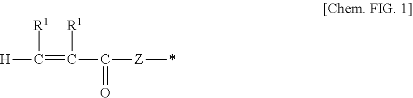

In the formula, R¹ mutually independently represents a hydrogen atom, a methyl group, or a phenyl group, and preferably a hydrogen atom or a methyl group in order to form an acryl group or a methacryl group moiety. Z represents a divalent organic group which may contain a hetero atom and is bonded to a silicon atom configuring the main chain of the polysiloxane represented by *, and may be a divalent organic group which may contain an oxygen atom, a nitrogen atom or a sulfur atom.

Specifically, Z preferably represents a group selected from: alkylene groups having 2 to 22 carbon atoms; divalent organic groups expressed by —R³—C(═O)—O—R⁴— {where R³ represents an alkylene group having 2 to 22 carbon atoms, and R⁴ represents a group selected from ethylene groups, propylene groups, methylethylene groups and hexylene groups}; and divalent organic groups expressed by —Z¹—X—C(═O)—X—Z²— {where Z¹ represents —O(CH₂)ₖ— (where k is a number in a range of 0 to 3), and X represents an oxygen atom, a nitrogen atom, or a sulfur atom. Z² represents —[(CH₂)₂O]ₘ(CH₂)ₙ— (where m is a number in a range of 0 to 3, and n is a number in a range of 3 to 10) bonded to a silicon atom configuring the main chain of the polysiloxane represented by *}.

Particularly preferably, the silicon-bonded functional group (R^{A}) is expressed by general formula (1-1):

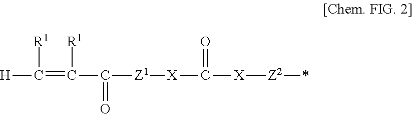

In the formula, R¹ mutually independently represents a hydrogen atom, a methyl group, or a phenyl group, and preferably a hydrogen atom or a methyl group. Z¹ represents —O(CH₂)ₖ— (k is a number in the range 0 to 3), where k is preferably 1 or 2. X represents an oxygen, nitrogen, or sulfur atom, and the X bonded to Z¹ preferably represents a nitrogen atom, and the X bonded to Z² preferably represents an oxygen atom. Z² represents a divalent organic group expressed by —[(CH₂)₂O]ₘ(CH₂)ₙ— (where m is a number in a range 0 to 3, n is a number in a range 3 to 10) bonded to a silicon atom forming the main chain of the polysiloxane represented by *, and the case where m is 1 and n is 3 is preferred for practical use. Note that the silicon atom-bonded functional group (RA) expressed by general formula (1-1) can be introduced into the molecule by reacting a silicon atom-bonded functional group containing at least one alcoholic hydroxyl group (R^{OH}), such as a carbinol modified group or the like, with an isocyanate compound having a radical-reactive carbon-carbon double bond in the presence of a condensation reaction catalyst. Furthermore, the same reaction may be and preferably is performed in the presence of a polymerization inhibitor such as dibutylhydroxytoluene (BHT).

Here, the isocyanate compound having a radical-reactive carbon-carbon double bond that provides the silicon atom-bonded functional group (R^{A}) is not particularly limited, but at least either of 2-methacryloyloxyethyl isocyanate or 2-acryloyloxyethyl isocyanate is preferred. The isocyanate compounds mentioned above include, for example, methacryloyl isocyanate, 2-methacryloyloxyethyl isocyanate, 2-acryloyloxyethyl isocyanate, m-isopropenyl-α,α-dimethylbenzylisocyanate, and the like. These are commercially available under trade names such as Carens MOI, Carens AOI, Carens BEI, and Carens MOI-EG, manufactured by Showa Denko.

A silicon atom-bonded functional group (R^{OH}) containing at least one alcoholic hydroxyl group is an organic group containing one or more alcoholic hydroxyl group moiety expressed by —CH₂—OH, and is a component that imparts condensation reactivity and heat-curing properties derived from the hydroxyl group. From the viewpoint of crosslinking reactivity, the co-modified organopolysiloxane of the present invention preferably contains at least two silicon atom-bonded functional groups (R^{OH}) in the molecule. Note that, as described above, the silicon atom-bonded functional group (R^{A}) can be derived from a silicon atom-bonded functional group (R^{OH}); therefore, molecular design of the co-modified organopolysiloxane can be easily performed by controlling the mass ratio of R^{A} and R^{OH} in the molecule by reacting with an isocyanate compound at a specific mass ratio with regard to the amount of R^{OH} to the precursor of the co-modified organopolysiloxane containing R^{OH}, such as carbinol modified group.

The silicon atom-bonded functional group (R^{OH}) is preferably one or more silicon atom-bonded functional group selected from carbinol modified groups, polyether modified groups, glycol modified groups, and glycerol modified groups, but carbinol modified groups are particularly preferable.

Preferably, an example of the functional group R^{OH} is a silicon atom-bonded carbinol-modified group expressed by the following general formula (2): HO—CH₂—Y—*. In the formula, Y represents a divalent organic group, which may contain a heteroatom, such as an oxygen atom, nitrogen atom, or sulfur atom, bonded to a silicon atom forming a main chain of the polysiloxane represented by *, and a bivalent organic group represented by

—CH₂O—[(CH₂)₂O]ₘ(CH₂)ₙ— (m is a number in the range of 0 to 3, n is a number in the range of 3 to 10), or the like is preferable for practical use.

Silicon atom-bonded carbinol modified groups expressed by the following general formula (2-1):

HO—CH₂—Y₁—O—Y₁—*

are particularly preferable.

In the formula, Y₁ each independently represents an alkylene group with 1 to 20 carbon atoms, and the rightmost Y₁ is bonded to a silicon atom forming the main chain of the polysiloxane represented by *. For practical use, Y₁ is preferably an alkylene group with 1 to 6 carbon atoms, such as a methylene group, ethylene group, butylene group, or the like.

In the co-modified organopolysiloxane of the present invention, the aforementioned silicon-bonded functional group (R^{A}) and silicon-bonded functional group (R^{OH}) may be bonded to a silicon atom at the molecular chain end of a chain siloxane, or may be a side chain modifying group bonded to a silicon atom on a polysiloxane main chain. In addition, the co-modified organopolysiloxane of the present invention may be a single organopolysiloxane or a mixture of two or more types of co-modified organopolysiloxanes having different degrees of siloxane polymerization, different modification ratios by R^{A} and R^{OH}, different main chain structures, or different end structures.

In the co-modified organopolysiloxane of the present invention, organic groups other than the aforementioned silicon-bonded functional group (R^{A}) and silicon-bonded functional group (R^{OH}) (hereinafter, also referred to as “another organic group”) may contain: a methyl group, an ethyl group, a propyl group, a butyl group, a pentyl group, a hexyl group, a heptyl group, or another alkyl group; a phenyl group, a tolyl group, a xylyl group, a naphthyl group, or another aryl group; a benzyl group, a phenethyl group, or another aralkyl group; a chloromethyl group, a 3-chloropropyl group, a 3,3,3-trifluoropropyl group, or other halogenated alkyl group; or the like. From an industrial perspective, it is particularly preferable to include a methyl group. On the other hand, from the perspective of elongation of the cured material particularly at high temperature, adhesion to the substrate, and transparency, and particularly reducing haze value, a methyl group is preferred as the other organic group in component (A), and the amount of aryl groups or aralkyl groups is less than 0.1 mol % of the total number of groups bonded to a silicon atom, and particularly 0.0 mol %, and thus the composition preferably does not contain an aryl group or an aralkyl group.

[(A) Use of Co-Modified Organopolysiloxane]

The co-modified organopolysiloxane of the present invention has both heat curability by a condensation reaction and photo-curability by irradiation with a high energy beam, and thus is suitable as a raw material for a curable organopolysiloxane composition, which is cured via a plurality of curing mechanisms or two or more curing steps. In addition, the co-modified organopolysiloxane of the present invention is particularly useful as an organopolysiloxane pressure-sensitive adhesive composition or as a raw material for a pressure-sensitive adhesive layer, which is characterized by a change in pressure-sensitive adhesive strength triggered by irradiation with high energy beam, and because coatable viscosity is provided, a semi-cured material obtained by a heat curing reaction has excellent initial pressure-sensitive adhesive strength to a substrate, unreacted silicon-bonded functional groups (R^{A}) form an easily releasable cured layer by a photo-curing reaction by irradiation with a high energy beam, and the pressure-sensitive adhesive strength to the substrate is greatly reduced.

[Curable Organopolysiloxane Composition]

The curable organopolysiloxane composition of the present invention contains the aforementioned (A) co-modified organopolysiloxane, and has both heat curability by a condensation reaction and photo-curability by irradiation with a high energy beam.

More specifically, the curable organopolysiloxane composition of the present invention contains:
(A) the co-modified organopolysiloxane of the present invention;
(B) an organic compound having at least two isocyanate groups in the molecule;
(C) a condensation reaction catalyst; and
(D) a photo-radical polymerization initiator, and optionally also contains:
(E) a bifunctional, both-end carbinol-modified organopolysiloxane;
(F) a polydimethylsiloxane which may optionally have an alkenyl group; and
(G) an organic solvent.

Descriptions of components (B) to (G) will be provided below.

[(B) Organic Compound Containing at Least Two Isocyanate Groups in a Molecule]

Component (B) is a component that functions as a cross-linking agent for the aforementioned curable organopolysiloxane composition, and can react with silicon atom-bonded functional groups (R^{OH}) such as carbinol modified groups in component (A) in the presence of a condensation reaction catalyst (C) to form a pressure-sensitive adhesive layer that is a semi-cured material. The pressure-sensitive adhesive layer has excellent initial pressure-sensitive adhesive strength to the base material, but includes unreacted photo-curable silicon atom-bonded functional groups (R^{A}), so the pressure-sensitive adhesive strength is greatly reduced by two-step curing triggered by high-energy beam irradiation, and thus easy release properties are exhibited.

Component (B) is an organic compound preferably having two or more isocyanate groups in one molecule, preferably three or more isocyanate groups, such as aliphatic polyisocyanates, alicyclic polyisocyanates, aromatic polyisocyanates, and the like. One type of compound may be used alone, or two or more types may be used in combination.

Aliphatic polyisocyanates include, for example, 1,2-ethylene diisocyanate; tetramethylene diisocyanates such as 1,2-tetramethylene diisocyanate, 1,3-tetramethylene diisocyanate, 1,4-tetramethylene diisocyanate, and the like; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, and the like; as well as 2-methyl-1,5-pentane diisocyanate, 3-methyl-1,5-pentane diisocyanate, lysine diisocyanate, and the like.

Alicyclic polyisocyanates include, for example, isophorone diisocyanate; cyclohexyl diisocyanates such as 1,2-cyclohexyl diisocyanate, 1,3-cyclohexyl diisocyanate, 1,4 cyclohexyl diisocyanate, and the like; cyclopentyl diisocyanates such as 1,2-cyclopentyl diisocyanate, 1,3-cyclopentyl diisocyanate, and the like; as well as hydrogenated xylylene diisocyanate, hydrogenated tolylene diisocyanate, hydrogenated diphenylmethane diisocyanate, hydrogenated tetramethylxylene diisocyanate, 4,4′-dicyclhexylmethane diisocyanate, and the like.

Aromatic polyisocyanates include, for example, 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, xylylene-1,3-diisocyanate, and the like.

Component (B) may be and preferably is a commercially available product such as “Duranate TPA-100” manufactured by Asahi Kasei Chemicals, “Coronate L”, “Coronate HL”, “Coronate HK”, “Coronate HX”, “Coronate 2096”, and the like, manufactured by Nippon Polyurethane Industry Co.

The amount of Component (B) can be selected based on the desired pressure-sensitive adhesive strength and curing properties, but from the viewpoint of initial pressure-sensitive adhesive strength and easy release properties triggered by high energy beam irradiation which are the issues of the present invention, a range of 0.1 to 10.0 parts by mass in 100 parts by mass of the aforementioned Component (A), co-modified organopolysiloxane, is preferred, a range of 0.1 to 5.0 parts by mass is preferable, 0.5 to 4.5 parts by mass is more preferable, and 1.0 to 3.5 parts by mass is especially preferable. If the amount of Component (B) that is used is less than the lower limit described above, there may be insufficient cross-linking agent, resulting in insufficient heat curability of the composition, but if the amount exceeds the upper limit described above, stickiness or adhesive residue may be induced in the cured material after irradiation with a high energy beam. Furthermore, suitably, the mass ratio {[OH]/[NCO]} between the total amount of alcoholic hydroxyl groups (—OH) in the composition (mainly derived from Component (A) and an arbitrary Component (E)) and the isocyanate groups (—NCO) in Component (B) is particularly preferably between 1.0 and 3.0.

[(C) Condensation Reaction Catalyst]

Component (C) is a condensation reaction catalyst, which is a component that promotes the condensation reaction of component (A), optionally the alcoholic hydroxyl group in component (E), and component (B) by heating or the like. Note that these condensation reaction catalysts may be the same or different from the condensation reaction catalyst used in deriving the silicon atom-bonded functional group (R^{A}) from the silicon atom-bonded functional group (R^{OH}) when synthesizing component (A), and may be brought into the composition in whole or in part during the synthetic process of component (A).

The condensation reaction catalyst is not particularly restricted, and examples may include: tin compounds such as dimethyltin dineodecanoate and stannous octoate, dibutyltin(IV) dilaurate, tin(I) chloride, tin(II) chloride, tetra-n-butyltin, trimethyltin hydroxide, tin octoate, diethyltin dichloride, and the like; titanium compounds such as tetra(isopropoxy)titanium, tetra(n-butoxy)titanium, tetra(t-butoxy)titanium, di(isopropoxy)bis(ethylacetoacetate)titanium, di(isopropoxy)bis(methylacetoacetate)titanium, titaniumtetraacetylacetonate, di(isopropoxy)bis(acetylacetonate)titanium, and the like; aluminum compounds such as aluminum trisacetriacetate, aluminum trisacetriacetate, tris(sec-butoxy)aluminum, and the like; nickel compounds such as nickel bisacetylacetonate and the like; cobalt compounds such as cobalt trisacetylacetonate, cobalt naphthenate, and the like; zinc compounds such as zinc bisacetylacetonate and the like; zirconium compounds such as zirconium tetra-n-propoxide, zirconium tetra-n-butoxide, zirconium tetraacetylacetonate, zirconium tributoxymonoacetylacetonate, zirconium monobutoxyacetylacetonate, zirconium dibutoxybis(ethylacetoacetate), zirconium tetraacetylacetonate, zirconium tributoxymono stearate, and the like; as well as chelates of lead, copper, iron, calcium, and the like; and tertiary amine catalysts such as tetramethylbutanediamine, 1,4-diazabicyclo[2,2,2] octane, 1,8-diazabicyclo[5,4,0] undecen-7, triethylenediamine, and the like. The condensation reaction catalyst may be one type or a mixture of two or more types.

The amount of component (C) that is used can be suitably designed based on the amount of Component (A) and Component (B) used in the reaction and the desired curing properties, but from the perspective of achieving heat curability and initial adhesion, the amount is 0.01 to 1000 ppm relative to 100 parts by mass of Component (A), preferably 50 to 500 ppm.

[(D) Photo-Radical Polymerization Initiator]

Component (D) is a photo-radical polymerization initiator, which accelerates the photo-curing reaction of the acryl group or methacryl group of the silicon atom-bonded functional group (R^{A}) in Component (A) by high energy beam irradiation. In particular, a cured material with easy release properties where the pressure-sensitive adhesive strength of the pressure-sensitive adhesive layer to the base material is greatly reduced is formed by irradiating the pressure-sensitive adhesive layer containing a semi-cured material containing unreacted functional groups (R^{A}) derived from Component (D) and Component (A) with high energy beams.

The photo-radical polymerization initiators are known to be broadly classified into photo-fragmentation and hydrogen abstraction types. However, the photo-radical polymerization initiator used in the composition of the present invention can be selected arbitrarily from those known in the technical field, and is not limited to any particular one. Examples of the photo-radical polymerization initiator include α-ketol compounds such as 4-(2-hydroxyethoxy)phenyl (2-hydroxy-2-propyl) ketone, α-hydroxy-α,α′-dimethylacetophenone, 2-methyl-2-hydroxypropiophenone, 1-hydroxycyclohexyl phenyl ketone, and the like; acetophenone compounds such as methoxyacetophenone, 2,2-dimethoxy-2-phenylacetophenone, 2,2-diethoxyacetophenone, 2-methyl-1-[4-(methylthio)-phenyl]-2-morpholinopropane-1, and the like; benzoin ether compounds such as benzoin ethyl ether, benzoin isopropyl ether, anisoin methyl ether, and the like; ketal compounds such as benzyl dimethyl ketal and the like; aromatic sulfonyl chloride compounds such as 2-naphthalenesulfonyl chloride and the like; photo-active oxime compounds such as 1-phenone-1,1-propanedione-2-(o-ethoxycarbonyl)oxime and the like; benzophenone compounds such as benzophenone, benzoylbenzoic acid, 3,3′-dimethyl-4-methoxybenzophenone, and the like; thioxanthone compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and the like; camphorquinone; halogenated ketones; acyl phosphinoxides; and acyl phosphonates; and the like.

The amount of component (D) used can be appropriately designed according to the amount of the silicon-bonded functional group (R^{A}) derived from component (A), as well as the desired change in the pressure-sensitive adhesive strength change and ease of releasability of a cured material triggered by irradiation with a high energy beam, but is preferably 0.1 to 10 parts by mass, and particularly preferably 0.5 to 5 parts by mass, with respect to 100 parts by mass of component (A).

[(D′) Photosensitizer]

A photosensitizer (D′) may be used in combination with an arbitrarily selected photo-radical polymerization initiator (D). Use of a sensitizer can increase the photon efficiency of the polymerization reaction, and is particularly effective when the coating thickness of the composition is relatively thick or when a relatively long-wavelength LED light source is used, because use of longer wavelength light for the polymerization reaction compared to only using a photoinitiator is feasible. Examples of known sensitizers include anthracene-based compounds, phenothiazine-based compounds, perylene-based compounds, cyanine-based compounds, melocyanine-based compounds, coumarin-based compounds, benzylidene ketone-based compounds, and (thio)xanthene or (thio)xanthone-based compounds such as isopropylthioxanthone, 2,4-diethylthioxanthone, squarylium-based compounds, (thia)pyrylium-based compounds, porphyrin-based compounds, and the like. Moreover, an arbitrary photosensitizer not limited thereto can be used in the curable organopolysiloxane composition and pressure-sensitive adhesive composition of the present invention. The amount used is arbitrary, but is commonly selected within a range where the mass ratio of Component (D′) to Component (D) is 0 to 10, and if present, is within a range of 0.01 to 5.

[(E) Bifunctional, Both-End Carbinol-Modified Organopolysiloxane]

In addition to Components (A) to (D), the composition of the present invention may contain a bifunctional, both-end carbinol-modified organopolysiloxane. Note that the range of Component (E) excludes those compounds that overlap with Component (A). Suitably, Component (E) is preferably dimethylpolysiloxane, which has a total of two carbinol-modified groups only at both ends of the molecular chain, and has no other curing-reactive functional groups.

Component (E) has a condensation-reactive carbinol-modified group at both ends of the siloxane molecule, and therefore can be incorporated into the crosslinked structure of the cured or semi-cured material as a chain extender to provide the cured material with appropriate flexibility and elongation. Furthermore, by using Component (E), the tackiness and crosslink density of the cured material can be adjusted, and the initial adhesion and hardness can be adjusted.

Component (E) has a carbinol-modified group bonded to a silicon atom at both ends of the siloxane molecular chain, and the same groups as the carbinol-modified groups suggested as the silicon atom-bonded functional groups (R^{OH}) above are suggested and are preferable. Component (E) is not restricted in structure and manufacturing method, so long as it has a carbinol-modified group at both ends of the siloxane molecular chain, but is easily and generally synthesized by a hydrosilylation reaction of a compound having an unsaturated group (carbon-carbon double bond) and a carbinol functional group in the molecule with a polyorganohydrogensiloxane having a silicon atom-bonded hydrogen atom at the end of the molecular chain.

Component (E) is suitably a polydimethylsiloxane having an organodimethylsiloxy group expressed by R^{car}(CH₃)₂SiO_{1/2} (where R^{car} is a carbinol-modified group) at both ends of the molecular chain, and the siloxane degree of polymerization is in a range of 5 to 1,000, preferably in a range of 10 to 500, or 50 to 400. Component (E), which is a dimethylpolysiloxane having a carbinol-modified group only at both ends, is particularly useful as a chain extender and as a component that adjusts viscosity, adhesion of cured or semi-cured materials, hardness, cross-link density, and the like, which are required of curable organopolysiloxane compositions for coatings.

Component (E) is an optional component, so it may be blended in an amount of 0.0 to 20 parts by mass relative to 100 parts by mass of Component (A), preferably 0.5 to 10 parts by mass, more preferably 0.0 to 10 parts by mass, and particularly preferably 1.0 to 7.5 parts by mass.

[(F) Polydimethylsiloxane which May Optionally have an Alkenyl Group]

The composition of the present invention may also include polydimethylsiloxane, which may optionally have an alkenyl group. Component (F) is not involved in the crosslinking reaction of Components (A) to (D) and optional component (E), but the viscosity required for coating with the curable organopolysiloxane composition, as well as the pressure-sensitive adhesion, hardness, crosslink density, and the like of the cured or semi-cured material can be adjusted by using this component, and furthermore, the release properties or the like of the cured material may be improved.

Herein, Component (A) and Component (E) are explicitly excluded from the range of Component (F), and Component (F) is suitably a cyclic, linear, branched, resinous, or raw rubber type polydimethylsiloxane in which a portion of the methyl groups may be replaced with an alkenyl group having 2 to 20 carbon atoms. The siloxane degree of polymerization and viscosity range thereof are not limited, but Component (F) may be a liquid polydimethylsiloxane with a viscosity at 25° C. in a range of 1.5 to 1,000,000 mPa-s, or having a viscosity of 100,000 mPa-s or more at 25° C., or may be a raw rubber type polydimethylsiloxane having a plasticity measured in accordance with the method specified in JIS K6249 (determined by measuring the thickness to 1/100 mm when a load of 1 kgf is applied to a spherical sample of 4.2 g for 3 minutes at 25° C., multiplied by 100) in the range of 50 to 200. Furthermore, the amount of the vinyl (CH₂═CH) moiety in the alkenyl group in Component (F) (hereinafter referred to as “vinyl amount”) is arbitrary, but may be in a range of 0.000 to 0.400% by mass or 0.005 to 0.300% by mass. Note that a cyclic polydimethylsiloxane with a siloxane degree of polymerization of 3 to 20, which may optionally have an alkenyl group, is included in the range of Component (F).

[(G) Organic Solvent]

The composition of the present invention can be designed as a composition with little or no solvent because the constituent components have relatively low viscosity, but an organic solvent (G) may be optionally added. The organic solvent may be used as a diluent to disperse or dissolve each component in order to improve the coating and wettability of the composition on the substrate, or may be unavoidably included as solvents associated with other raw material components.

While not particularly limited, as long as the technical effects of the present invention are not hindered, the type of organic solvent used herein may be a compound which is soluble with all of the components in the composition or a portion of the components, and a type having a boiling point of 80° C. or more and of 200° C. or less is preferably used. The type of solvent can be a non-halogenated or halogenated solvent, aromatic hydrocarbon solvent, aliphatic hydrocarbon solvent, ester solvent, alcohol solvent, ether solvent, chlorinated aliphatic hydrocarbon solvent, volatile oil solvent, or the like, and combinations of two or more types can be used depending on the coating properties, wetting properties, and the like.

More specifically, examples include non-halogen solvents such as i-propyl alcohols, t-butyl alcohol, cyclohexanol, cyclohexanone, methyl ethyl ketone, methyl isobutyl ketone, toluene, xylene, benzene, heptane, hexane, octane, isoparaffin, mesitylene, 1,4-dioxane, dibutyl ether, anisole, 4-methyl anisole, ethyl benzene, ethoxy benzene, ethylene glycol, diisopropyl ether, 1,4-dioxane, ethylene glycol dimethyl ether, ethylene glycol diethyl ether, 2-methoxy ethanol (ethylene glycol monomethyl ether), diethylene glycol dimethyl ether, diethylene glycol monomethyl ether, dipropylene glycol methyl ether acetate, ethyl acetate, butyl acetate, propyl propionates (=propyl propionate), 1-methoxy-2-propyl acetate, 1-ethoxy-2-propyl acetate, octamethyl cyclotetrasiloxane, and hexamethyl disiloxane; and halogen solvents such as trichloroethylene, perchloroethylene, methylene chloride, trifluoromethyl benzene, 1,2-bis (trifluoromethyl)benzene, 1,3-bis (trifluoromethyl)benzene, 1,4-bis (trifluoromethyl)benzene, trifluoromethyl chlorobenzenes, trifluoromethyl fluorobenzene, and hydrofluoroether.

The amount of organic solvent is less than 0 to 60 mass %, particularly preferably less than 50%, and substantially in a range of 0 to 30%, based on a total of 100 parts by mass of the composition. In particular, when Components (A) to (D) and optionally Component (F), or the like of the present invention are used, the solid fraction concentration that forms a solid fraction by the curing reaction can be easily designed to be in a range of 30 to 100% by mass of the entire composition.

[Other Optional Components]

The curable organopolysiloxane composition of the present invention may optionally contain components other than the components described above to an extent that does not impair the technical effects of the present invention. For example, the composition may contain: an adhesion promoter; a non-reactive organopolysiloxane other than Component (F) such as a polydimethyldiphenylsiloxane; an antioxidant such as a phenol-type, a quinone-type, an amine-type, a phosphorus-type, a phosphite-type, a sulfur-type, or a thioether-type antioxidant; a light stabilizer such as triazoles or benzophenones; a flame retardant such as a phosphate ester-type, a halogen-type, a phosphorus-type, or an antimony-type flame retardant; and one or more types of antistatic agents consisting of a cationic surfactant, an anionic surfactant, a non-ionic surfactant, or the like. Note that in addition to these components, pigments, dyes, inorganic microparticles (reinforcing fillers, dielectric fillers, conductive fillers, thermally conductive fillers), and the like can be optionally blended.

The method of preparing the curable organopolysiloxane composition of the present invention is not particularly limited and is performed by homogeneously mixing the respective components. An organic solvent may be added as necessary, and the composition may be prepared by mixing using a known stirrer or kneader. Note that the composition has condensation reactivity when heated, and is therefore preferably mixed at a temperature of less than 100° C., preferably less than 50° C.

[Method of Use as Pressure-Sensitive Adhesive Layer]

The curable organopolysiloxane composition of the present invention has both heat curability and photo-curability by irradiation with a high-energy beam because the composition contains the aforementioned Component (A). In particular, the semi-cured material which is the condensation reaction product obtained by heat curing functions as a pressure-sensitive adhesive layer with excellent initial pressure-sensitive adhesive strength, and the pressure-sensitive adhesive strength to the base material of the pressure-sensitive adhesive layer is greatly reduced by irradiating with a high-energy beam, and the composition can be easily removed by forming an easily peelable cured material. The method of use will be described below.

[Application and Heat Curing]

The curable organopolysiloxane composition of the present invention is applied to a base material to form a coating film, which is then heated to a temperature of 80 to 150° C., preferably 90 to 110° C., to provide a semi-cured material that functions as a pressure-sensitive adhesive layer with excellent initial pressure-sensitive adhesive strength due to the condensation reaction between alcoholic hydroxyl groups and isocyanate groups in the composition. Note that the heating time required for curing can be selected according to the thickness of the pressure-sensitive adhesive layer and the amount of catalyst used, but is generally in a range of 0.5 to 90 minutes. The pressure-sensitive adhesive layer obtained by heat curing the composition of the present invention contains unreacted silicon atom-bonded functional groups (RA), and thus maintains further photo-curing reactivity triggered by irradiation with a high energy beam.

Examples of application methods include gravure coating, offset coating, offset gravure, roll coating, reverse roll coating, air knife coating, curtain coating, and comma coating. The coating amount can be designed at a desired thickness in accordance with the application such as a display device; for example, the thickness of the pressure-sensitive adhesive layer after curing may be from 1 to 1000 μm, from 5 to 900 μm, or from 10 to 800 μm; however, there is no limitation thereto.

The semi-cured material prior to the photo-curing reaction has sufficient initial pressure-sensitive adhesive strength. For example, when designing a pressure-sensitive adhesive layer with a thickness of 75 μm, a pressure-sensitive adhesive layer can be designed with a pressure-sensitive adhesive strength to an SUS plate at a tensile speed of 300 mm/min using the 180° peeling test method according to JIS Z 0237 that is 2.5 gf/inch or higher, preferably, 3.0 gf/inch or higher, and in particular, 3.0 to 50.0 gf/inch. Note that the thickness (75 μm) described above is the thickness of the cured layer itself serving as a reference for objectively defining the pressure-sensitive adhesive strength of the cured layer of the present invention. It goes without saying that the curable organopolysiloxane composition of the present invention is not limited to a thickness of 75 μm and may be used as a cured layer or a pressure-sensitive adhesive layer of an arbitrary thickness.

[Change in Pressure-Sensitive Adhesive Strength by Irradiation with High Energy Beam]

The pressure-sensitive adhesive layer, which is a semi-cured material obtained by heat curing, undergoes a further photo-curing reaction triggered by irradiation with a high energy beam, greatly reducing the pressure-sensitive adhesive strength, forming a hard cured material that is easily peelable and that does not leave adhesive residue on the base material, or the like, allowing the layer to be easily detached from the base material. Specifically, when the organopolysiloxane semi-cured product obtained by a heat curing reaction is closely adhered to another substrate, the pressure-sensitive adhesive strength to the substrate decreases by 10% or more, preferably 30% or more, and particularly preferably 50% or more, before and after a photo-curing reaction by irradiation with a high energy beam. Note that such changes in the pressure-sensitive adhesive strength can be quantitatively measured by a pressure-sensitive adhesive strength measurement test using the aforementioned SUS plate or the like.

Examples of the high energy beam used in the photo-curing reaction (also referred to as active energy beam) include ultraviolet beams, electron beams, radiation beams, and the like, but ultraviolet beams are preferable from the perspective of practicality. As the ultraviolet ray generating source, a high-pressure mercury lamp, a medium-pressure mercury lamp, a Xe-Hg lamp, a deep UV lamp, or the like is suitable, and in particular, ultraviolet irradiating with a wavelength of 280 to 400 nm, preferably with a wavelength of 300 to 400 nm is preferable, and a light source with a plurality of emission bands may be used.

Although the irradiation amount of the high energy beam can be designed as appropriate, when the UV irradiation amount (irradiance) is 100 mJ/cm² to 10,000 mJ/cm², and preferably 1,000 mJ/cm² to 5,000 mJ/cm² as the integrated light intensity, the high energy beam irradiation triggers a favorable change in the pressure-sensitive adhesive strength of the pressure-sensitive adhesive layer of the present invention. Note that the high energy beam irradiation may be performed with the substrate sandwiched in between, so long as the substrate supporting the pressure-sensitive adhesive layer of the present invention does not absorb electromagnetic waves in the above wavelength region. In other words, if a certain amount of irradiation is feasible, high energy beam irradiation may be performed over a cover material such as a substrate, protective film, or the like.

[Properties Related to Transparency, Color Tone, or Coloration and Discoloration of Pressure-Sensitive Adhesive Layer]

The pressure-sensitive adhesive layer (including semi-cured and cured products) obtained by curing the curable organopolysiloxane composition and organopolysiloxane pressure-sensitive adhesive composition of the present invention may be substantially transparent, semi-transparent, or opaque, and the transparency can be designed according to the application of the pressure-sensitive adhesive layer. When it is visually transparent, or more objectively, when the value for air is 100%, the transmittance of light at a wavelength of 450 nm of the pressure-sensitive adhesive layer formed from a cured layer having a thickness of 100 μm is 80% or higher, and preferably 90% or higher, and may be designed so as to be 95% or higher. On the other hand, with the pressure-sensitive adhesive or the like for temporary retaining or the like when light transmissivity is not required, a semi-transparent to opaque pressure-sensitive adhesive layer may be used with a filler component or additive which impairs colorability or light transmittance.

[Method of Use as Pressure-Sensitive Adhesive Layer, Pressure-Sensitive Adhesive Sheet with Change in Pressure-Sensitive Adhesive Properties Before and After Irradiation with High Energy Beam]

In order to improve close adhesion with an adherend, the pressure-sensitive adhesive layer of the present invention may be subjected to a surface treatment such as primer treatment, corona treatment, etching treatment, plasma treatment, and the like on the surface of the pressure-sensitive adhesive layer of the present invention or the substrate. However, the close adhesion layer of the present invention has excellent close adhesion to a substrate of a display device and the like as described above. Therefore, these steps may be added, as required, to further improve close adhesion with the adherend, with a higher production efficiency capable of being achieved by eliminating these steps.

The curable organopolysiloxane composition of the present invention is semi-cured by a condensation reaction by applying the composition to a release liner, then heating under the temperature conditions described above, and after the release liner is peeled off and the composition is attached to a film-like substrate, a tape-like substrate, or a sheet-like substrate (hereinafter, referred to as a “film-like substrate”) is applied to a film-like substrate, and curing by heating at the temperature conditions described above so as to form a pressure-sensitive adhesive layer on the surface of the substrate can be performed. As described above, the pressure-sensitive adhesive layer has excellent initial adhesion and contains a photo-curable functional group derived from component (A), which is triggered by high energy beam irradiation to decrease pressure-sensitive adhesive strength and change pressure-sensitive adhesive properties on easy releasability.

A laminate, provided with a cured layer, in particular, a film-like cured layer, obtained by curing the organopolysiloxane composition of the present invention on a film-like substrate, may be used as adhesive tape, detachable protective film, adhesive bandage, low temperature support, transfer film, label, emblem, and decorative or explanatory sign. Further, a cured layer obtained by curing the organopolysiloxane composition of the present invention may be used to assemble automobile parts, toys, electronic circuits, or keyboards. Alternatively, a cured layer formed by curing the organopolysiloxane composition of the present invention, particularly a film-like adhesive layer, may be used in the production, construction, and use of a laminated touch screen or flat panel display.

Exemplary types of substrates include paperboard, cardboard paper, clay-coated papers, polyolefin laminate papers, particularly polyethylene laminate papers, synthetic resin films and sheets, natural fiber woven materials, synthetic fiber woven materials, artificial leather materials, and metal foils. In particular, synthetic resin films and sheets are preferable, with exemplary synthetic resins including: polyimides, polyethylenes, polypropylenes, polystyrenes, polyvinyl chlorides, polyvinylidene chlorides, polycarbonates, polyethylene terephthalates, cyclopolyolefins, and nylons. When heat resistance is required, a heat-resistant synthetic resin film such as a polyimide, polyetheretherketone, polyethylene naphthalate (PEN), liquid crystal polyacrylate, polyamide-imide, polyether sulfone, and the like is particularly preferable. At the same time, for applications such as a display device in which visibility is required, a transparent substrate and specifically a transparent material such as a polypropylene, polystyrene, polyvinylidene chloride, polycarbonate, polyethylene terephthalate, PEN, and the like is preferable.

The substrate is preferably a film-like or sheet-like substrate. The thickness thereof is not particularly limited and can be designed with a desired thickness in accordance with the application. Furthermore, in order to improve the adhesion between a supporting film and cured adhesive layer, a supporting film subjected to a primer treatment, corona treatment, etching treatment, or plasma treatment may be used. Furthermore, the surface of the film-like substrate on the opposite side as the cured layer or cured adhesive layer surface may be subjected to surface treatments such as a treatment for scratch prevention, grime prevention, fingerprint adhesion prevention, anti-glare, anti-reflection, anti-static, or other treatment.

The pressure-sensitive adhesive layer of the present invention may be a single layer or a multilayer structure obtained by laminating two or more pressure-sensitive adhesive layers in accordance with the required properties. The multilayered pressure-sensitive adhesive layer may be made by laminating adhesive films made one layer at a time, or by performing the process of coating and curing the curable silicone composition a plurality of times, such as on a film substrate with a release layer.

The pressure-sensitive adhesive layer of the present invention may serve as another functional layer selected from a dielectric layer, conductive layer, heat dissipation layer, insulating layer, reinforcing layer, and the like, in addition to providing bonding or adhering between members. In particular, the pressure-sensitive adhesive layer, which is a semi-cured product obtained by heat curing the curable organopolysiloxane of the present invention, has excellent initial adhesion and contains a photo-curable functional group derived from component (A), which is triggered by high energy beam irradiation to decrease pressure-sensitive adhesive strength and change pressure-sensitive adhesive properties on easy releasability, thereby forming a cured close adhesion layer that can be very easily removed from a substrate surface by high energy beam after fixing or adhering with the desired device or process. Therefore, the pressure-sensitive adhesive layer is very useful for temporary fixing or the like of a temporary functional layer or a functional layer that is supposed to be attached or detached.

In the case of a pressure-sensitive adhesive layer obtained by heat curing the curable organopolysiloxane composition of the present invention, in particular, a pressure-sensitive adhesive sheet with a change in pressure-sensitive adhesive properties before and after high energy beam irradiation, the pressure-sensitive adhesive layer is preferably handled as a laminated body film closely adhered in a releasable state on a film substrate provided with a release layer with release coating capability. The release layer may also be referred to as a release liner, a separator, a release layer, or a release coating layer, and may preferably be a release layer having a release coating function such as a silicone-based release agent, a fluorine-based release agent, an alkyd-based release agent, a fluorosilicone-based release agent, or the like, or may have physically fine irregularities formed on a substrate surface, such that the adhesive layer of the present invention will not easily adhered to the substrate. In particular, the laminated body of the present invention preferably has a release layer obtained by curing a fluorosilicone release agent as the release layer.

The pressure-sensitive adhesive layer of the present invention has the characteristic pressure-sensitive adhesive properties described above and can achieve transparency and low haze, and thus is useful as an elastic close adhesion layer or temporary fixing layer, as a member of various electronic apparatuses or electrical devices, and as a protective film during processing of a semiconductor wafer. Similarly, the cured material is useful as an electronic material, a member for a display device, or a member for a transducer (including sensors, speakers, actuators, and generators), and a suitable application for the cured material is a member of an electronic component or display device. The cured material of the present invention may be transparent or opaque, and in particular, a film-shaped cured material, particularly a substantially transparent protective film, is suitable as a member of a display panel or display, and is particularly useful in so-called touch panel applications in which a device, particularly an electronic device, can be operated by touching a screen with a fingertip or the like. Note that the cured material layer of the present invention is not required to have transparency, and may be suitable for applications as a film or sheet-like member that is used in sensors, speakers, actuators, and the like that require a certain degree of elasticity or flexibility of the adhesive layer itself.

[Use as an Adhesive Tape]

An article containing a cured layer obtained by curing the curable silicone composition of the present invention can be an adhesive tape, and particularly a supposedly detachable protective tape, and has a sheet-like member made of the aforementioned adhesive layer and a synthetic resin film or sheet, metal foil, woven material, nonwoven material, paper, or other fiber product. The type of adhesive tape is not particularly limited, and includes insulating tapes, heat-resistant tapes, solder masking tapes, mica tape binders, temporary fixing tapes (including in particular temporary fixing tapes for silicone rubber parts, and the like), splicing tapes (including in particular splicing tapes for silicone release paper).

In particular, the cured material, especially the cured layer, made by curing the curable silicone composition of the present invention has excellent initial pressure-sensitive adhesive properties, and because the cured material contains photo-curing functional groups derived from Component (A), the adhesive properties and appearance of the adhesive layer are stable because the pressure-sensitive adhesive strength is reduced and the pressure-sensitive adhesive properties change to enable easy release when triggered by high energy beam irradiation, and after use, the adhesion layer can be easily removed from the surface of the base material by irradiation with UV or the like, and therefore the cured material is particularly useful as a functional film that is temporarily used in display devices, semiconductors, and the like, on the premise of being detachable. In particular, as described below, the present invention is extremely useful as a pressure-sensitive adhesive for temporarily fixing for use when manufacturing a display device such as a CRT display, liquid crystal display, plasma display, organic EL display, inorganic EL display, LED display, surface electrolytic display (SED), field emitting displays (FED), and other display devices, or touch panels using the display devices.

[Laminates and Adhesive Sheets]

A laminate with a cured adhesive layer made by curing the curable silicone composition may be formed on a film substrate, and suitably, these film substrates may be provided with a release layer for the cured adhesive layer.

The laminate body of the present invention preferably has a sheet-like substrate with at least one release layer, and the release layer is preferably in contact with the cured adhesive layer. Therefore, the cured adhesive layer can easily be peeled off from the sheet-like substrate. The release agent contained in the release layer is not particularly limited, and the same release agents as described above may be suggested.

In particular, the laminate body may be able to handle the adhesive layer separated from the film-like substrate alone, or there may be two film-like substrates.

Specifically, the laminate body may have:
a film-like substrate;
a first release layer formed on the film-like substrate;
a pressure-sensitive adhesive layer formed by applying, heating, and curing the curable organopolysiloxane composition on the release layer; and
a second release layer laminated on the adhesive layer.

Furthermore, a laminate body with this form may be produced, for example, by interposing the curable silicone composition described above between the first film-like substrate and the second film-like substrate, to form a layer to a certain thickness by pressing or rolling while heating, and then curing the composition.

The first sheet substrate may be provided with a first release layer, or the first sheet substrate itself may be provided with releasability. Similarly, the second sheet substrate may be provided with a second release layer, or the second sheet substrate itself may be provided with releasability. When the first sheet substrate and/or the second sheet substrate is provided with a first release layer and/or a second release layer, the cured adhesive layer is preferably in contact with the first release layer and/or the second release layer.

For example, the sheet substrate having releasability includes a sheet substrate made of a material having releasability such as a fluororesin film, or a sheet substrate made of a material having no or low releasability such as a polyolefin film to which a release agent such as silicone or fluoroplastic has been added. On the other hand, the sheet substrate provided with the release layer includes, for example, a polyolefin film coated with a release agent such as silicone or fluororesin.

The aforementioned laminate can be used, for example, by peeling the adhesive layer from the film substrate after applying the cured adhesive layer to the adherend.

The thickness of the close adhesion layer (pressure-sensitive adhesive layer) obtained by heat curing the curable organopolysiloxane composition of the present invention is preferably 5 to 10,000 μm, preferably 10 μm or more or 8,000 μm or less, and particularly preferably 20 μm or more and 5,000 μm or less.

[Member for Display Panel or Display]

The tightly bonded layer (pressure-sensitive adhesive layer) made by heating and curing the curable organopolysiloxane composition of the present invention can be used for protection, construction, or use in a laminate touch screen or flat-panel display, and the specific method of use can be a commonly known method of use of adhesive layers (for example, silicone PSA, silicone adhesives, and silicone sealing agents), without limitation.

### INDUSTRIAL APPLICABILITY

The application of the co-modified organopolysiloxane of the present invention, a curable organopolysiloxane composition containing the same, and a pressure-sensitive adhesive layer obtained by semi-curing/curing the same are not limited to those disclosed above, and a film provided with the cured product obtained by curing the composition can be used in various display devices for displaying characters, symbols and images. The surface shape of such a display device may be a curved shape or a bowed shape rather than a flat surface, with examples thereof including curved displays or curved transmission screens used in automobiles (including electric vehicles), aircraft, or the like, in addition to various flat panel displays (FPDs). Furthermore, these display devices may have an additional touch panel function that allows input operations by touching icons, notification displays, or operation buttons for executing functions or programs on the screen or display using a finger. Application thereof is possible as a device for CRT displays, liquid crystal displays, plasma displays, organic EL displays, inorganic EL displays, LED displays, surface electrolytic displays (SEDs), field emitting displays (FEDs), and other display devices, or touch panels using the display devices. Moreover, the cured material obtained by curing the composition has excellent adhesion to a substrate and viscoelastic properties, and can be used as a film-like or sheet-like member, which is a member for transducers such as a membrane for speakers (including a sensor, speaker, actuator, and generator), in addition to also being capable of being used as a sealing layer or adhesive layer used in a secondary battery, fuel cell, or solar cell module.

### EXAMPLES

Hereinafter, the present invention is described in detail with reference to the Examples and Comparative Examples, but it should be understood that the present invention is not limited to these Examples. In addition, due to the nature of the semi-cured product of the present invention, the high energy beam irradiation is not performed at the same time as heat curing.

### Example S1: Synthesis Example 1

100.0 g of side-chain carbinol-modified polysiloxane expressed by the following formula:

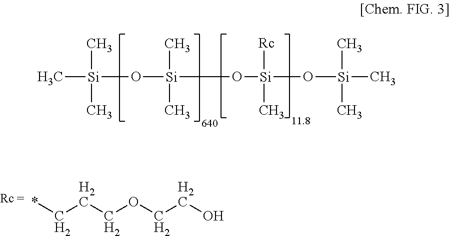

2.4 g of 2-isocyanatoethyl methacrylate (CAS No.: 30674-80-7, Carens MOI, Showa Denko), and 0.01 g of dibutylhydroxytoluene (BHT) as a polymerization inhibitor were blended. 0.0050 g of dimethyl tin dineodecanoate (CAS No. 68928-76-7) was added as a catalyst, and then the mixture was stirred at 80° C. for 1 hour. The elimination of isocyanate groups was confirmed by IR spectroscopy, and then 102 g of bifunctional organopolysiloxane having carbinol group and a methacryloyl group expressed by the following formula:

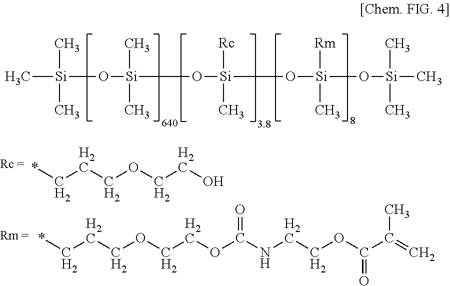

was obtained by removing the low boiling point components under reduced pressure. The ratio of isocyanate groups to carbinol groups was calculated by ¹³CNMR measurement.

### Example S2: Synthesis Example 2

100.0 g of side-chain carbinol-modified polysiloxane expressed by the following formula:

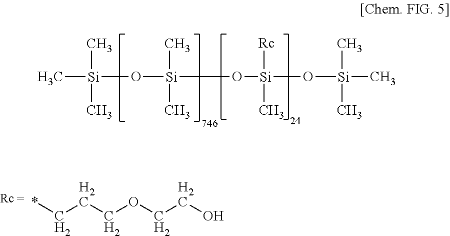

4.9 g of 2-isocyanatoethyl methacrylate (CAS No.: 30674-80-7, Carens MOI, Showa Denko), and 0.02 g of dibutylhydroxytoluene (BHT) as a polymerization inhibitor were blended. 0.0050 g of dimethyl tin dineodecanoate (CAS No. 68928-76-7) was added as a catalyst, and then the mixture was stirred at 80° C. for 1 hour. The elimination of isocyanate groups was confirmed by IR spectroscopy, and then 105 g of the bifunctional organopolysiloxane having carbinol group and a methacryloyl group expressed by the following formula:

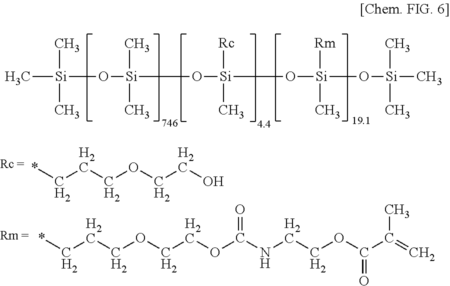

was obtained by removing the low boiling point components under reduced pressure. The ratio of isocyanate groups to carbinol groups was calculated by ¹³CNMR measurement.
Component (A-1): Bifunctional organopolysiloxane with carbinol and methacryloyl groups (amount of OH groups: 0.13 mass %, amount of methacrylate groups: 1.34 mass %) as described in Synthesis Example (1)
Component (A-2): Bifunctional organopolysiloxane with carbinol and methacryloyl groups (amount of OH groups: 0.12 mass %, amount of methacrylate groups: 2.61 mass %) as described in Synthesis Example (2)
Component (A′): Organopolysiloxane having only a carbinol group as described in Synthesis Example (1) (amount of OH groups: 0.41 mass %, amount of methacrylate groups: 0.0 mass %)

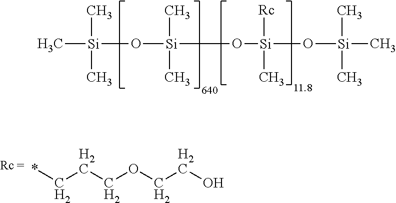

B: Triisocyanate expressed by the following formula

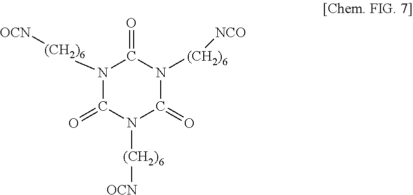

(Product name: Coronate HX fluid, manufactured by Tosoh Corporation)

C: Fomrez UL-28 Catalyst (dimethyl tin dineodecanoate, manufactured by Galata Chemicals)

D: 2,2-dimethoxy-2-phenylacetophenone (CAS #: 24650-42-8, manufactured by Tokyo Chemical Industry Co., Ltd.)

E: Bifunctional carbinol-modified polysiloxane expressed by the following formula:

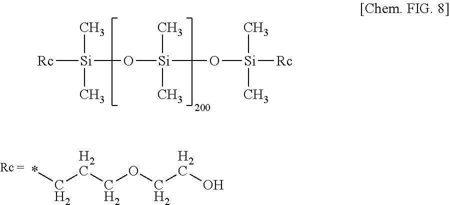

F: Methyl butyl ketone (MIBK)

### Examples 1 to 5, Comparative Examples 1 to 2

Examples of the present invention and comparative examples are described hereinafter. Note that “cured” in each of the examples, comparative examples, and reference examples indicates that each composition has fully cured under the respective curing conditions.

(Preparation of a Curing Reactive Silicone Composition)

A pressure-sensitive adhesive composition containing the curable reactive organopolysiloxane compositions illustrated in each of the examples and comparative examples was prepared using the components shown in Table 1. Note that all percentages in Table 1 refer to mass %.

(Pressure-Sensitive Adhesive Strength Measured Initially and after UV Irradiation)

Each composition was applied to a PET film (available from Toray Co., Ltd., product name: Lumirror (registered trademark) S10, thickness: 50 μm) such that the thickness after curing was 75 μm, after which it was cured for 5 minutes at 100° C. After leaving the sample for 1 hour, the sample was cut to a width of 20 mm and the adhesive layer side was attached to an SUS plate (made by Paltech) using a roller to make a test piece. The pressure-sensitive adhesive strength measured on an SUS plate at a tensile rate of 300 mm/min using the 180° peel test method in according with JIS Z 0237 is shown in Table 1 as “Initial pressure-sensitive adhesive strength”. In addition, the test piece was irradiated with UV rays with a wavelength of 365 nm from a PET surface side using a UV-LED UV irradiation device (available from JATEC) such that the amount of UV irradiation (irradiance) was 2,000 mJ/cm² as an integrated light intensity. The pressure-sensitive adhesive strength of the test piece after UV irradiation was measured in the same manner as described above and is shown in Table 1 as “Pressure-sensitive adhesive strength after UV irradiation”.

*Check for presence of adhesive residue

TABLE 1

| | | | | | | Comparative | |
|---|---|---|---|---|---|---|---|
| | Examples | | | | | Examples | |
| Component | 1 | 2 | 3 | 4 | 5 | 1 | 2 |
| A-1 | 100 | 100 | 100 | | | | |
| A-2 | | | | 100 | 100 | | |
| A′ | | | | | | 100 | 100 |
| B Crosslinking agent | 1.6 | 2.0 | 1.2 | 1.6 | 2.1 | 1.6 | 2 |
| Tin catalyst C (ppm) | 200 | 200 | 200 | 200 | 200 | 200 | 200 |
| Photopolymerization | 2.1 | 2.2 | 2.1 | 3.2 | 3.2 | 2 | 2 |
| initiator D | | | | | | | |
| Additive E | 3.2 | 5.5 | 0.0 | 0.0 | 3.2 | 2.9 | 4.9 |
| Solvent F MIBK | 96.0 | 96.0 | 65.0 | 104.8 | 108.5 | 57.8 | 59.2 |
| Solid fraction | 76% | 76% | 82% | 50% | 50% | 84% | 83% |
| concentration wt % | | | | | | | |
| OH/NCO ratio | 1.5 | 2 | 1.5 | 1.5 | 1.5 | 1.5 | 1.5 |
| Methacryl group | 0.6 | 0.6 | 0.6 | 1.2 | 1.2 | 0 | 0 |
| content mol % | | | | | | | |
| Carbinol/methacryl | 0.5 | 0.5 | 0.2 | 0.2 | 0.2 | — | — |
| group ratio | | | | | | | |
| (R^{OH}/R^{A}) | | | | | | | |
| Initial pressure- | 9.1 | 8.8 | 3.5 | 6 | 6.3 | 2.2 | 1.8 |
| sensitive adhesive | | | | | | | |
| strength to SUS plate | | | | | | | |
| g/inch | | | | | | | |
| pressure-sensitive | 3.5 | 3.6 | 3 | 1.9 | 3 | 4.3 | 2.5 |
| adhesive strength to | | | | | | | |
| SUS plate after UV | | | | | | | |
| irradiation | | | | | | | |
| g/inch | | | | | | | |

As shown in Table 1, the heat cured products of the composition containing the co-modified organopolysiloxane of the present invention according to Examples 1 to 5 have an initial adhesive strength in a range sufficient for practical use, and can achieve a pressure-sensitive adhesive strength in a certain range by composition design. Furthermore, the pressure-sensitive adhesive layer had pressure-sensitive adhesive strength greatly reduced by UV irradiation, changing the pressure-sensitive adhesive properties to be easy peelable. Therefore, it is expected to excel in usefulness as a protective film, temporary fixing film, and the like when used in a manufacturing process of a semiconductor wafer and the like and display devices, electronic devices, and the like. On the other hand, when an organopolysiloxane having only a carbinol-modified group was used, as in Comparative Examples 1 and 2, only slight pressure-sensitive adhesive properties could be achieved, and the pressure-sensitive adhesive strength was regrettably increased by UV irradiation. Therefore, it was difficult to maintain the initial pressure-sensitive adhesive strength while maintaining easy peelability after use, unless the co-modified organopolysiloxane of the present invention was used.

1. A chain co-modified organopolysiloxane, comprising:
a silicon atom-bonded functional group containing an acrylic or methacryl group (R^{A}) and a silicon atom-bonded functional group containing at least one alcoholic hydroxyl group (R^{OH}), as expressed by the following General Formula (1), wherein the amount of the silicon atom-bonded functional groups (R^{A}) is in a range of 0.10 to 10.0 mol % of all functional groups bonded to a silicon atom that forms the polysiloxane molecule, and the average mass of silicon atom-bonded functional group (R^{OH}) containing at least one alcoholic hydroxyl group (R^{OH}) is 0.1 to 1.0 mole per mole of silicon atom-bonded functional group;
General Formula (1): 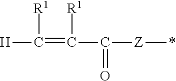
where R¹ mutually independently represents a hydrogen atom, a methyl group, or a phenyl group, and Z represents a divalent organic group which may contain a hetero atom and is bonded to a silicon atom configuring a main chain of a polysiloxane represented by *.

2. The co-modified organopolysiloxane according to claim 1, wherein the aforementioned functional group R^{OH} is one or more type of silicon atom-bonded functional groups selected from carbinol-modified, polyether-modified, glycol-modified, and glycerol-modified groups, containing one or more alcoholic hydroxyl group moieties expressed by —CH₂—OH.

3. The co-modified organopolysiloxane according to claim 1, wherein the aforementioned functional group R^{OH} is a silicon atom-bonded carbinol modified group expressed by the following
HO—CH₂—Y—* General Formula (2):
where Y represents a divalent organic group which may contain a hetero atom and is bonded to a silicon atom forming a main chain of a polysiloxane represented by *.

4. The co-modified organopolysiloxane according to claim 1, wherein the aforementioned functional group R^{OH} is a silicon atom-bonded carbinol modified group expressed by the following
HO—CH₂—Y₁—O—Y₁—* General Formula (2-1):
where Y₁ each independently represents an alkylene group with 1 to 20 carbon atoms, and the rightmost Y₁ is bonded to a silicon atom forming the main chain of the polysiloxane represented by *.

5. The co-modified organopolysiloxane according to claim 1, wherein the two or more of the functional groups R^{OH} are provided in a molecule.

6. The co-modified organopolysiloxane according to claim 1, wherein the functional group R^{A} is a functional group expressed by the following
General Formula (1-1): 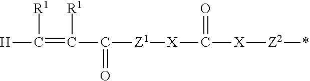
where R¹ mutually independently represents a hydrogen atom, a methyl group, or a phenyl group; Z¹ represents —O(CH₂)ₖ— where (k is a number in the range of 0 to 3; and X represents an oxygen atom, a nitrogen atom, or a sulfur atom; Z² represents a divalent organic group expressed by —[(CH₂)₂O]ₘ(CH₂)ₙ— where m is a number in a range 0 to 3, and n is a number in a range 3 to 10, bonded to a silicon atom forming the main chain of the polysiloxane represented by *.

7. The co-modified organopolysiloxane according to claim 1, wherein the main chain of the polysiloxane is a straight chain.

8. A curable organopolysiloxane composition, comprising:
(A) 100 parts by mass of the co-modified organopolysiloxane according to claim 1;
(B) 0.1 to 10.0 parts by mass of an organic compound containing at least two isocyanate groups in a molecule;
(C) 0.01 to 1000 ppm of a condensation reaction catalyst with respect to component (A); and
(D) 0.1 to 10 parts by mass of a photo-radical polymerization initiator.

9. The curable organopolysiloxane composition according to claim 8, further comprising: (E) 0 to 20 parts by mass of a bifunctional both-end carbinol-modified organopolysiloxane.

10. The curable organopolysiloxane composition according to claim 8, further comprising: (F) a polydimethylsiloxane which may optionally have an alkenyl group; and/or (G) an organic solvent.

11. The curable organopolysiloxane composition according to claim 8, having both heat curability and photo-curability by irradiation with a high energy beam.

12. The curable organopolysiloxane composition according to claim 8, wherein when the organopolysiloxane semi-cured product obtained by a heat curing reaction is closely adhered to another substrate, the pressure-sensitive adhesive strength to the substrate decreases by 50% or more before and after a photo-curing reaction by irradiation with a high energy beam.

13. An organopolysiloxane pressure-sensitive adhesive composition, comprising the co-modified organopolysiloxane according to claim 1.

14. An organopolysiloxane pressure-sensitive adhesive layer obtained by curing or semi-curing the curable organopolysiloxane composition according to claim 8.

15. A method of using an organopolysiloxane adhesive composition, comprising:
(I): a step of applying the organopolysiloxane pressure-sensitive adhesive composition according to claim 13 on a substrate;
(II): a step of semi-curing the organopolysiloxane pressure-sensitive adhesive composition applied in step (I) by a heat curing reaction; and
(III): a step of further curing the semi-cured material obtained in step (II) using a photo-curing reaction by irradiating with a high-energy beam;
wherein the pressure-sensitive adhesive strength of the semi-cured product obtained in step (II) to another base material is reduced by irradiation with a high energy beam in step (III).

16. The curable organopolysiloxane composition according to claim 9, wherein component (E) is present.

17. The curable organopolysiloxane composition according to claim 16, further comprising: (F) a polydimethylsiloxane which may optionally have an alkenyl group; and/or (G) an organic solvent.

18. The curable organopolysiloxane composition according to claim 17, wherein component (G) is present.
